(19) United States
(12) Patent Application Publication
(10) Pub. No.: US 2010/0026515 A1
(43) Pub. Date: Feb. 4, 2010

(54) Utility Metering System With Compact And Robust Antenna For Subsurface Installation

(76) Inventors: Mark Lazar, New Berlin, WI (US); Randy Schultz, Fredonia, WI (US); Dennis Webb, Glendale, WI (US); Shlomo Izicovich, Ramla (IL); Yarum Locker, Givat Shmuel (IL); Erez Sharabi, Tel Aviv (IL)

Correspondence Address: BOYLE FREDRICKSON S.C., 840 North Plankinton Avenue, MILWAUKEE, WI, 53203, US

(21) Appl. No.: 12/181,676

(22) Filed: Jul. 29, 2008

(51) Int. Cl. G08C 17/02

(52) U.S. Cl. 340/870.02

(57) ABSTRACT

A pit transmitter assembly (10) for RF communication of signals representing utility meter data, includes a transmitter (60) supported by a transmitter substrate (61), a planar ground conductor (43) disposed over the transmitter (60), an antenna substrate (42) disposed on edge on the planar ground conductor (43), a flat coil antenna conductor (41) disposed on two opposite sides of the antenna substrate (42) and in which the transmitter (60) includes an L-C circuit (50) connected to the antenna conductor (41) to provide operation of the antenna in the 450 Mhz-470 Mhz frequency range.

### TECHNICAL FIELD

This invention relates to utility meters and in particular to meters located in a pit enclosure in the ground and having a radio transmitter for transmitting metering signals to a receiver in a stationary, non-mobile networks.

### DESCRIPTION OF THE BACKGROUND ART

In moderate climate zones, utility meters are located in subsurface enclosures in areas adjacent to residences or other dwellings. Such enclosures are referred to as “pits” or “pit boxes.” An example of such enclosure is illustrated in Cerny et al., U.S. Pat. No. 5,298,894, in which a utility meter transmitter is disposed in a pit and includes an antenna projecting above the lid to transmit RF signals to an RF interrogator unit. The transmitter antenna may be installed in pits which are made in whole or in part of cast iron, plastic, or concrete. The lids of these boxes are generally flush with ground level.

The amount of radio frequency energy actually radiated into the airwaves is a function of a number of factors. Such factors may include the location of the antenna relative to ground level, the shape and configuration of the antenna, other materials in close proximity of the antenna, other signals which interact with signals from the antenna, the energy transmitted to the antenna for radiation, and the electrical frequency of operation.

One type of antenna conventionally used for utility meter remote transmitters used was a loop antenna. This type of antenna has been suitable for mobile collection units operating in the unlicensed band around 915 Mhz, where transmissions are required to reach distances of a few hundred feet. It is now desired to develop an antenna for use with a fixed network, automatic meter reading system. Such a system may be required to transmit signals over distances of more than 1,000 feet and up to distances of ½ mile or more. Such a system can also be operated in the frequency range of 450 Mhz to 470 Mhz. In this range of operation, it is more difficult to make the antenna a small component, so as to fit into a pit transmitter housing.

In this environment, the antenna must provide greater performance at smaller size and without unduly increasing power requirements which are generally provided by an onboard battery.

The radio frequency energy radiation pattern from the antenna should be controlled and should be as uniform in three-dimensional space as possible.

### SUMMARY OF THE INVENTION

The invention provides an assembly for radio frequency (RF) communication of signals representing utility meter data. The assembly includes a flat coil antenna conductor disposed on a substrate which is further disposed on edge perpendicular to a conductive ground plane within a transmitter housing. An L-C tuning circuit is connected to the antenna conductor to provide operation of the antenna in the 450 Mhz-470 Mhz frequency range.

By placing the substrate on edge, the antenna can be positioned to radiate in directions both upwardly and laterally and at points in between to radiate energy nearly uniformly in three-dimensional space.

The antenna can be disposed with a transmitter in a tube of less than one and one-half inches in diameter and projects at least 30 mm above the pit lid.

The invention provides an antenna conductor with individual coils having a preferred angle of inclination of approximately seventy-four degrees relative to the ground conductor.

Other objects and advantages of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a side view in elevational view of a meter transmitter assembly disposed in a pit and connected to a water meter;

FIG. 2 is an enlarged view of the meter transmitter assembly of FIG. 1, with parts broken away for a view of the interior;

FIG. 3 is a schematic view of an antenna according to the present invention;

FIG. 4 is a schematic of a circuit for determining the frequency range of operation for the antenna;

FIG. 5 is a plan view of a circuit assembly that includes an antenna of the present invention;

FIGS. 6 and 7 and front and side elevation views of the transmitter assembly of the present invention removed from its housing as seen in FIGS. 1 and 2.

### DETAILED DESCRIPTION OF THE PREFERRED EMBODIMENTS

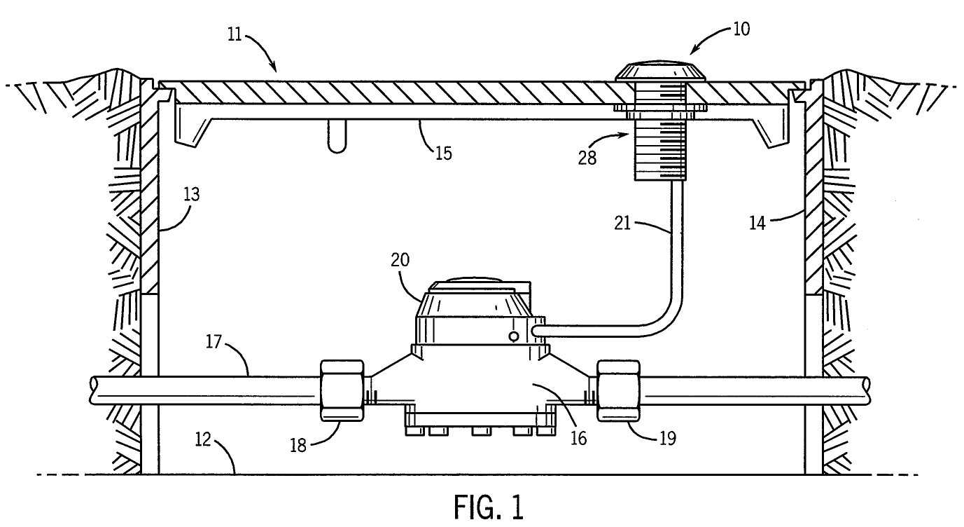

Referring to FIG. 1, the invention is provided for a pit transmitter assembly 10 to be used in a subsurface pit enclosure 11. The pit is typically made of metal, concrete or other materials and includes sidewalls 13, 14 and a lid 15 which is removable to open the enclosure 11 for access. A bottom wall 12 is optional. The pit enclosure 11 is located along the route of water supply pipe 17. A water meter housing 16 is connected in the water supply line 17, using hex-head nuts 18, 19 which are sealed in a conventional manner against leaks at the connecting points. A water meter register unit 20 is mounted on top of the water meter housing 16. As known in the art, meter registers convert mechanical movements of a meter to visual and numerical representations of consumption often shown in an odometer-type read-out device. The register 20 is preferably a unit that is commercially distributed by Badger Meter, Inc., the assignee of the present invention, under the trade designation “Recordall” Transmitter Register (RTR). Besides displaying units of consumption, this device 20 uses a pulse transmitter that is described in Strobel et al., U.S. Pat. No. 4,868,566, entitled “Flexible Piezoelectric Switch Activated Metering Pulse Generators, ” to translate the mechanical movements of the meter to electrical signals.

The register 20 connects via a twisted pair, shielded cable 21 to a transmitter assembly 10, which is housed in a tubular housing 28 of cylindrical shape. The housing is formed of plastic material and extends downwardly from the pit lid 15. The register 20 transmits electrical signals to the transmitter assembly 10, for further transmission through a radio network.

The transmitter assembly 10 communicates via low power RF signals with a receiver which is preferably a fixed, non-mobile receiver in a meter data acquisition system. The pit transmitter assembly 10 transmits an electronic message that includes an identification code, meter reading data, and an error code for checking the data at the receiving end. The meter data is collected from various customer locations for billing purposes.

Referring to FIG. 2, the tubular housing 28 is formed with threads 36 formed around the outside, with an open lower end and a closed upper end. When the pit transmitter assembly 10 is installed, the tubular housing 28 extends through a hole 29 in the pit lid 15 as shown in FIG. 2. Although the invention is advantageous where space is limited, it is also possible that the antenna of the present invention could be used in housings of other shapes, such as a rectangular shape, for one example.

As seen in FIG. 2, a low-profile cap 22 has a circular opening 27 with an inside circumferential thread that engages the thread 36 on the tubular housing 28 as seen in FIG. 1. The cap 22 is screwed onto the threads 36 and has a flat bottom side which engages a top side of the pit lid 15 to suspend the transmitter assembly 10 from the pit lid 15.

As seen in FIG. 2 the pit transmitter assembly 10 also includes a collar 38 which can be turned onto the lower end of the tube 28 to trap a portion of the pit lid 15 between it and the underside of the cap 22. The collar 38 also includes a flange 37. With the cap 22 and the collar 38 attached to the housing 28 there is a three-inch variable length or height adjustment for the portion of the tubular housing 28 that extends through the pit lid 15.

As further seen in FIG. 2, the tubular housing 28 has an open bottom end that is sealed and an integrally formed, closed top end. An antenna assembly 40 for the transmitter is positioned inside the top end of the enclosure 28 to project above the pit lid 15 by the required distance. The cap 22 is screwed onto the tube 28 above the top side of the lid 15 to hold the tubular housing 28 at the maximum allowed height above the pit cover 15. Due to the physical constraints of the size of hole in the pit lid and the maximum height of any item projecting from it, the transmitting antenna must also be limited in height and width.

Possible antenna types include an inverted-F antenna, a dielectric antenna, an annular slot antenna loaded with a coaxial resonator and a loaded monopole antenna. All of these antennas radiate efficiently, when their total length is approximately λ/4 (167 mm) and their height is at least 30 mm above the ground surface (above the lid). In order to obtain the required performance, these existing antennas need an enclosure tube 28 with an internal diameter of at least 53 mm (about 1¾ inches) and they would need to project above the metal pit lid by at least 30 mm (1⅛ inches). Fitting these existing antennas into a plastic tube with the limited dimensions, would significantly reduce the performance in gain, in frequency bandwidth and in impedance matching, to an unacceptable level.

The antenna assembly 40 of the present invention can be assembled in a transmitter assembly 60 and positioned in a tubular housing 28 or in another type of enclosure that protrudes a minimal height of 30 mm above the pit lid 15.

A technical problem to be overcome by the invention is a design of an efficient antenna with sufficient gain (better than −11 dBi) that can provide the required performance (gain, bandwidth) in the frequency range of 450-470 MHz. In addition, the antenna has to radiate omni-directionally in both azimuth and elevation.

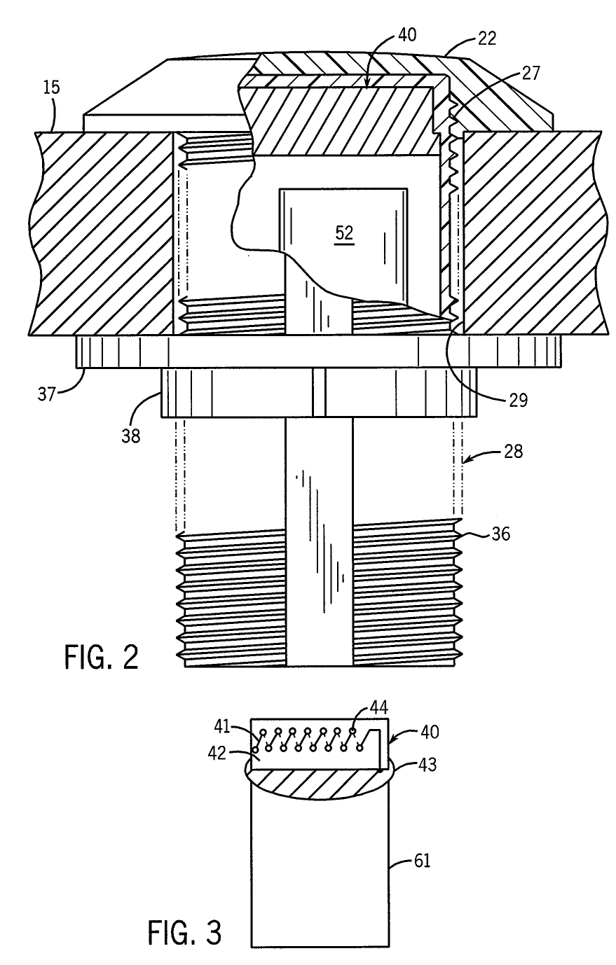

In the preferred embodiment shown in FIGS. 3 and 5, the antenna 41 is a flat coil antenna conductor with half coil portions 41a, 41b printed and alternating on two opposite sides of a thin substrate in the form of circuit board 42. The coil 41 is alternated and printed on the two respective sides of the PCB 42 with plated through holes 44 (known as vias) connecting the half coils on the two sides.

The antenna coil 42 has individual coils with an optimized and preferred inclination angle 45 of seventy-four degrees (74°) from the ground plane. The invention can also be practiced with coils presenting an acute angle of inclination relative to the ground plane in a range from 60 degrees to 87 degrees.

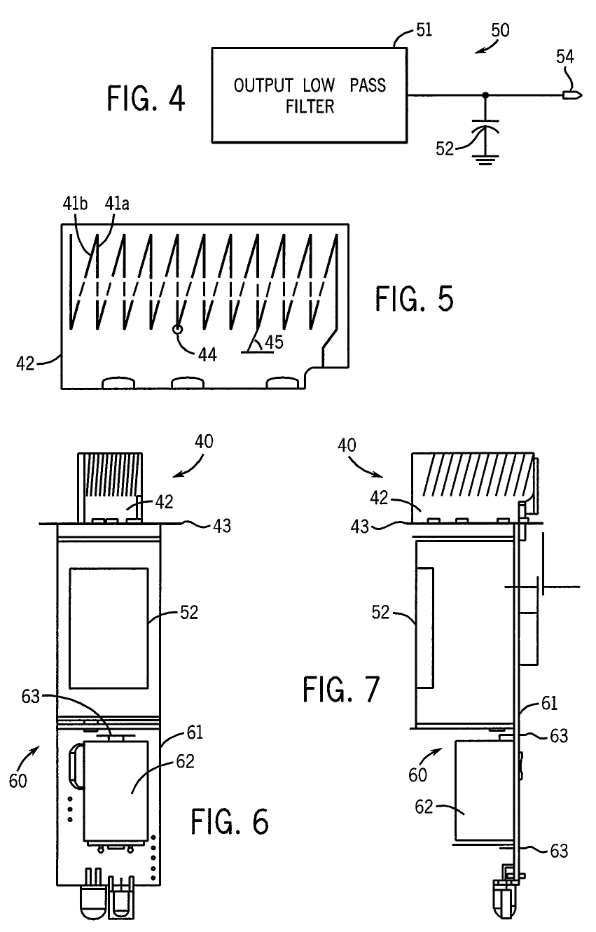

As seen in FIG. 3, a ground plane 43 is provided by a round disc of planar conductive material, usually made of metal or a metal alloy, which is positioned generally horizontal and parallel to the ground when assembled in the housing 28. The antenna assembly 40 is mounted with its circuit board 42 on edge and perpendicular to the ground plane 43. The circuit board 42 in the preferred embodiment has a height of about ¾ inch. An LC circuit 50 is connected to the antenna in FIGS. 3 and 5 at the antenna input 54 in FIG. 4 to obtain impedance matching and to increase the power efficiency of the antenna 41 in the frequency range of 450-470 MHz.

The geometry of the antenna 41 is different (L-shaped) and the type of loading is different (printed coil) from a loaded monopole antenna. This provides the necessary size to fit into the plastic tube without significant sacrifice of the radiation efficiency.

FIGS. 6 and 7 show a physical representation of the transmitter assembly 60 including the antenna assembly 40. The transmitter is formed on a circuit board 61. A battery 62 for providing power to the assembly 60 is received between contacts 63 that are mounted on the circuit board 61. Also seen in a capacitor 52 of a size and rating (6 picofarads) necessary to provide tuning of the antenna circuit to the frequency range of 450-470 MHz.

FIG. 4 shows an electrical schematic of an impedance-matched L-C circuit 50 provided in a transmitter assembly 60. The circuit 50 includes a low pass filter with inductive (L) elements and a capacitor (C) 52 of 6 picofarads, which seen both in the schematic of FIG. 4 and in physical representation in FIGS. 7 and 8. The circuit 50 includes a terminal 54 for connection to the antenna 41. This circuit 50 provides the necessary gain response in a frequency range of 450 to 470 Mhz.

The antenna 41 fits the plastic tube dimensions (38 mm diameter) and protrudes to the maximum permitted height above the top surface of the pit lid 15. The metal pit lid 15 itself serves as an extension of the antenna's ground plane 43, which enhances its radiation efficiency. The radiation pattern of the antenna is omni-directional in azimuth and elevation.

The main polarization of the antenna in azimuth is vertical and its gain is better than −12 dBi for all azimuth angles in the transmitter frequency range 450-470 MHz. The antenna return loss is better than −10 dB over the entire frequency bandwidth. In contrast to other antenna solutions, the proposed antenna in its plastic housing is significantly less sensitive to intrusions such as snow, dirt or leaves deposited on the pit lid surface.

This has been a description of the preferred embodiments, but it will be apparent to those of ordinary skill in the art that variations may be made in the details of these specific embodiments without departing from the scope and spirit of the present invention, and that such variations are intended to be encompassed by the following claims.

We claim:

1. An assembly for RF communication of signals representing utility meter data, the assembly comprising:
transmitter circuitry;
a transmitter substrate supporting the transmitter circuitry, the transmitter substrate being disposed in a generally vertical direction for operation;
a planar ground conductor disposed over the transmitter and substrate and disposed generally horizontally for operation;
an antenna substrate disposed on edge on the planar ground conductor;
a flat coil antenna conductor disposed on two opposite sides of the antenna substrate; and
the transmitter circuitry including an L-C circuit connected to the antenna conductor to provide operation of the antenna in a 450 Mhz-470 Mhz frequency range.

2. The assembly of claim 1, wherein the antenna conductor has individual coils with an angle of inclination in a range from sixty degrees to eighty-seven degrees relative to the ground conductor.

3. The assembly of claim 1, wherein the antenna conductor has individual coils with an angle of inclination of approximately seventy-four degrees relative to the ground conductor.

4. The assembly of claim 1, wherein the flat coil antenna conductor has alternating half coils disposed on two respective sides of the antenna substrate.

5. The assembly of claim 1, wherein the width of the assembly is limited to 38 mm.

6. The assembly of claim 1, wherein the assembly can be disposed in a tubular housing with the antenna projecting at least 30 mm above a pit lid for a subsurface enclosure for a utility meter.

7. The assembly of claim 1, further comprising a housing of insulating material in which the transmitter, the transmitter substrate, the antenna and the antenna substrate are disposed.

8. The assembly of claim 7, wherein the housing has a tubular shape.

9. The assembly of claim 1, further comprising contacts on the transmitter substrate for receiving a battery.
